(19) United States
(12) Patent Application Publication
(10) Pub. No.: US 2022/0347748 A1
(43) Pub. Date: Nov. 3, 2022

(54) PROCESS FOR PURIFYING METAL NANOWIRES

(71) Applicant: COMMISSARIAT A L'ENERGIE ATOMIQUE ET AUX ENERGIES ALTERNATIVES, Paris (FR)

(72) Inventors: Jean-Pierre SIMONATO, Grenoble Cedex 09 (FR); Caroline CELLE, Grenoble Cedex 09 (FR); Bruno LAGUITTON, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/623,984

(22) PCT Filed: Jun. 26, 2020
(86) PCT No.: PCT/EP2020/068098

§ 371 Date: Dec. 30, 2021

(30) Foreign Application Priority Data
Jul. 2, 2019 (FR) 19 07312

(51) Int. Cl. B22F 9/24; B22F 1/145

(52) U.S. Cl. CPC B22F 9/24; B22F 1/147; B22F 2301/255; B22F 2304/054

(57) ABSTRACT

The present invention relates to a process for purifying metal nanowires, comprising at least the following steps: (i) providing a suspension of metal nano-objects in a hydroalcoholic solvent medium having a viscosity at 25° C. strictly less than 10 mPa·s, the metal nano-objects including fine nanowires and additional nanoparticles different from the fine nanowires; (ii) adding, to the metal nano-object suspension, metalloid or metal oxide nanoparticles having a diameter less than or equal to 50% of the average diameter of the nanowires; (iii) allowing the suspension of metal nano-objects with the added metalloid or metal oxide nanoparticles to settle under conditions conducive to the precipitation of the fine metal nanowires; and (iv) recovering the settled solids made from the fine metal nanowires.

### TECHNICAL FIELD

The present invention relates to a novel process for purifying thin metal nanowires, such as silver nanowires, having a high aspect ratio, more particularly having an aspect ratio of greater than or equal to 50, and having an average diameter of less than or equal to 60 nm.

### PRIOR ART

Metal nanowires, in particular silver nanowires, find a particularly interesting application in the manufacture of transparent electrically conductive materials, in particular of transparent electrodes which are of interest for optoelectronic applications (touchscreens, heating films, OLEDs, photovoltaic cells).

Recent advances in the field of nanotechnology have shown that metal nanowires, for example silver nanowires, represent a particularly advantageous alternative to films based on transparent conductive oxides (known under the abbreviation TCOs), for example based on indium tin oxide, which are traditionally used for the production of transparent electrodes.

A conductive and transparent system based on metal nanowires can in that case be obtained by forming, from a suspension of nanowires in a solvent (for example, in water, methanol, isopropanol, etc.), a percolating network of metal nanowires on a surface, for example a glass surface. Numerous advantages are associated with this manufacturing process: low cost, flexibility of the electrodes obtained, wet and low-temperature processibility, etc., as described in the publication by Langley et al. [1].

The performance criteria of the conductive system based on metal nanowires are determined according to the applications envisaged, the performance in terms of surface resistance (also called “sheet resistance”) and of optical properties, in particular transmittance and haze factor, being of primary importance.

Metal nanowires are generally produced easily and in large quantities by chemical synthesis in solution via the reduction of metal salts, for example of silver nitrate for obtaining silver nanowires, by a polyol, typically ethylene glycol. Unfortunately, this synthesis in solution is not a selective reaction, and impurities are produced during the synthesis, in particular metal nanoparticles having a low aspect ratio, for example of the rod type.

However, it is desirable to be able to use thin nanowires, with the exclusion of other particles, in particular nanowires having an average diameter of less than 60 nm, typically between 30 and 40 nm, for obtaining transparent conductive systems which meet the above-mentioned performance criteria, possessing a low haze factor and a good electrical conductivity. Such systems prove to be particularly useful for many optoelectronic applications.

To this end, it is necessary to obtain solutions of silver nanowires which are free from impurities, and in particular free from nanoparticles having a low aspect ratio (length/diameter strictly less than 30).

To achieve this, purification after synthesis of the nanowires is essential, since the synthesis inevitably co-produces undesirable objects. Various processes have already been proposed for performing this purification, such as centrifugation, precipitation or settling out. By way of example, application EP 3 145 661 proposes a particularly efficient double settling-out system.

Unfortunately, the proposed purification processes are not entirely satisfactory in the context of thin metal nanowires having a small diameter, typically having an average diameter of less than 60 nm, and having a high aspect ratio (length/diameter ratio), typically of greater than 50. In particular, for the purification of thin nanowires, the processes proposed to date require a very long purification time, in particular for the settling-out step. Furthermore, the purity of the products obtained is not always sufficient, with the undesirable presence of residual nanoparticles or of nanowires having low aspect ratios.

Therefore, there remains a need for an efficient purification process for thin metal nanowires.

The present invention aims precisely to meet this need.

### SUMMARY OF THE INVENTION

More specifically, the present invention relates to a process for purifying metal nanowires comprising at least the steps consisting in:

(i) providing a suspension of metal nano-objects in an aqueous-alcoholic solvent medium having a viscosity at 25° C. of strictly less than 10 mPa·s, said metal nano-objects including:
nanowires, referred to as “thin nanowires”, having an aspect ratio of greater than or equal to 50 and an average diameter of less than or equal to 60 nm; and
secondary nanoparticles, distinct from said thin nanowires, having an aspect ratio of less than or equal to 30, in particular less than or equal to 10, and a volume-average equivalent diameter of less than or equal to 200 nm;

(ii) adding, to said suspension of metal nano-objects, nanoparticles of metal or metalloid oxide(s) having a diameter of less than or equal to 50% of the average diameter of the nanowires;

(iii) leaving the suspension of metal nano-objects supplemented with said nanoparticles of metal or metalloid oxide(s) to settle out under conditions conducive to the precipitation of said thin metal nanowires; and

(iv) recovering the settled material formed from said thin metal nanowires.

In the continuation of the text, the term “thin nanowires” is intended to denote metal nanowires, in particular silver nanowires, having an aspect ratio (length/diameter ratio) of greater than or equal to 50 and an average diameter of less than or equal to 60 nm.

The process of the invention proves to be more particularly useful for isolating the thin metal nanowires from other secondary metal nanoparticles having a low aspect ratio that are present in the reaction mixture on conclusion of the synthesis of the metal nanowires in solution.

According to a particular embodiment, as described in the continuation of the text, the suspension of metal nano-objects in step (i) of the process of the invention is obtained, from the reaction mixture obtained on conclusion of a conventional synthesis of nanowires in solution, by carrying out a first settling-out step, as described in document EP 3 021 230, aiming to remove a portion of the undesirable small particles.

The nanoparticles of metal or metalloid oxide(s) employed according to the invention can be composed of a material chosen from metal oxides, metalloid oxides, and mixtures thereof, in particular from alumina (Al₂O₃), silica (SiO₂), and iron, manganese, titanium and zinc oxides. Preferably, they are silica nanoparticles.

The nanoparticles of metal or metalloid oxide(s) are more particularly introduced into the suspension of metal nano-objects comprising said thin nanowires of interest in a thin metal nanowires/nanoparticles of metal or metalloid oxide(s) ratio by mass of between 1:1 and 1:100, preferably between 1:2 and 1:20 and more preferentially from 1:8 to 1:12, in particular around 1:10.

The use of silica nanoparticles together with silver nanowires has already been proposed in the context of the preparation of nanocomposites based on an epoxy resin, for the purposes of improving and facilitating the dispersion of the silver nanowires in the polymer matrix without affecting the quality of the inter-object contacts ([2], [3]).

However, to the knowledge of the inventors, it has never been proposed to use nanoparticles of metal or metalloid oxide(s), such as silica nanoparticles, during the process for purifying metal nanowires.

Surprisingly, the inventors have found that the addition of nanoparticles of metal or metalloid oxide(s), such as silica nanoparticles, to the suspension of nano-objects including thin metal nanowires to be purified, advantageously enables an optimization of the process for purification by settling out.

Without wishing to be bound by theory, the nanoparticles of metal or metalloid oxide(s) become deposited on the thin metal nanowires.

In particular, by supplementing the suspension of thin nanowires to be purified, prior to the settling-out step, with nanoparticles of metal or metalloid oxide(s), it is possible to advantageously accelerate the settling-out phenomena and yet at the same time to obtain a better separation between the undesirable nanoparticles having a low aspect ratio and the thin nanowires of interest.

Thus, as illustrated in the examples that follow, the purification by settling out according to the invention can be performed in a significantly reduced duration compared to a settling out carried out from a suspension of metal nano-objects without addition of nanoparticles of metal or metalloid oxide(s). Advantageously, efficient settling out can thus be carried out in a duration of less than 6 hours, in particular between 2 and 4 hours. The process thus makes it possible to save a significant amount of time, and thus to save on the use of synthesis and purification tools.

What is more, the purification process according to the invention makes it possible to achieve, with a rapid settling out, an improved selectivity in the separation between the thin metal nanowires and the other secondary metal nanoparticles. Thus, the settled material formed from thin metal nanowires, obtained on conclusion of the settling out assisted by the nanoparticles of metal or metalloid oxide(s) according to the invention, exhibits less than 5% metal nanoparticles distinct from the thin metal nanowires of interest. The yield of thin metal nanowires is also improved, even for a rapid settling out, typically of a duration of less than 6 hours. For instance, the process of the invention makes it possible to recover, on conclusion of the settling out, more than 70%, in particular more than 80%, of the thin metal nanowires present in the starting suspension of metal nano-objects.

Thus, the process of the invention makes it possible to combine an acceleration of the purification by settling out, a gain in performance and a better selectivity of the separation between the thin nanowires of interest and the secondary metal nanoparticles.

Lastly, the process of the invention, based on a settling-out process, is particularly easy and inexpensive to implement. In particular, it does not require long and costly centrifugation steps.

Other characteristics, variants and advantages of the process of the invention will emerge more clearly on reading the description, the examples and figures which follow, which are given by way of illustration and not by way of limitation of the invention.

In the continuation of the text, the expressions “between . . . and . . . ”, “ranging from . . . to . . . ” and “varying from . . . to . . . ” are equivalent and are intended to mean that the limits are included, unless mentioned otherwise.

Unless otherwise indicated, the expression “comprising a/an” should be understood as “comprising at least one”.

### BRIEF DESCRIPTION OF THE DRAWINGS

FIG. 1 shows an image, obtained by scanning electron microscopy (SEM), of thin silver nanowires.

FIG. 2 shows an image, obtained by scanning electron microscopy (SEM), of thin silver nanowires after addition of silica nanoparticles, as described in example 3 which follows.

### DETAILED DESCRIPTION

Suspension of Nanowires to be Purified

As mentioned above, the process of the invention is useful for isolating thin metal nanowires from a suspension containing other undesirable secondary metal nanoparticles.

Thin Metal Nanowires

For the purposes of the invention, the term “thin” nanowires is intended to denote metal nanowires having an aspect ratio of greater than or equal to 50 and a diameter of less than or equal to 60 nm.

In particular, the thin metal nanowires have an average diameter ranging from 10 to 60 nm, in particular from 20 to 50 nm and more particularly from 30 to 40 nm.

The average length of the nanowires may more particularly be between 0.5 μm and 200 μm, in particular between 1 μm and 50 μm.

The dimensions of the metal nanowires can be evaluated by transmission electron microscopy (TEM) or by scanning electron microscopy (SEM). The average diameter (average length) is understood to be the average value of the diameters (lengths) of a population of nanowires.

The aspect ratio corresponds to the length/diameter ratio. Preferably, the thin metal nanowires more particularly have an aspect ratio of strictly greater than 50, preferably greater than or equal to 100 and more preferentially greater than or equal to 150, in particular greater than or equal to 200 and more particularly between 200 and 1000.

Thus, the thin metal nanowires to be isolated according to the invention can more particularly be metal nanowires having an average diameter of between 20 and 50 nm and an aspect ratio of greater than or equal to 200.

The metal nanowires are formed from a metallic material, which may be chosen from elemental metals. The metallic material may also be a bimetallic material or a metal alloy which comprises at least two types of metal, for example cupronickel (alloy of copper and nickel).

Preferably, the nanowires are formed from one or more metals. By way of example, mention may in particular be made of silver, gold, copper, nickel, core-shell systems having a core of copper, silver, nickel, platinum or palladium.

According to a particular embodiment, the metal nanowires of the invention are silver-based, gold-based, copper-based and/or nickel-based nanowires, that is to say that their composition by mass comprises at least 50% by mass of one or more of these metals. In particular, the metal nanowires are silver, gold, copper and/or nickel nanowires.

According to a particular embodiment, the metal nanowires according to the invention are silver or copper nanowires.

Preferably, the metal nanowires according to the invention are silver nanowires.

Secondary Metal Nanoparticles

The term “secondary metal nanoparticles” denotes the metal nano-objects present in said starting suspension and distinct from the thin nanowires according to the invention.

These nanoparticles are of the same chemical nature as the metal nanowires to be isolated. They are more particularly metal nanoparticles co-produced during the synthesis of the metal nanowires.

The term “distinct from the thin nanowires” is intended to signify the fact that the secondary metal nanoparticles do not satisfy the criteria in terms of aspect ratio and/or diameter of the thin metal nanowires to be isolated.

These nanoparticles may be of spherical or anisotropic morphology.

The secondary metal nanoparticles more particularly have an aspect ratio of less than or equal to 30, in particular less than or equal to 10, particularly between 1 and 8 and more particularly between 2 and 5.

They may more particularly have a volume-average equivalent diameter of less than or equal to 200 nm, in particular less than or equal to 100 nm and more particularly between 1 and 50 nm.

The term “equivalent diameter” of a particle is intended to mean the diameter of a sphere having the same volume as the particle. The average equivalent diameter is the average value by volume of the equivalent diameters of a population of particles. This average equivalent diameter can be determined by laser particle size analysis, by dynamic light scattering (DLS) or by scanning electron microscopy.

In particular, the secondary metal nanoparticles may have a greatest dimension of strictly less than 200 nm, in particular between 1 and 100 nm. They may for example be particles which are spherical on the whole and have an average diameter of between 5 and 80 nm.

The term “dimensions” of a particle is intended to mean the size of the particle measured along the different axes (x), (y) and (z) of an orthogonal coordinate system. For example, in the case of a rod-type particle, the dimensions of the particle may be its length and its diameter. In the case of a particle of spherical shape, dimensions measured along each of the axes (x), (y) and (z) are identical and correspond to the diameter of the particle.

The secondary metal nanoparticles distinct from said thin nanowires may thus be nanoparticles which are spherical on the whole, or highly anisotropic nanoparticles such as rods.

The rods may for example have an average diameter of greater than or equal to 200 nm and an aspect ratio typically of between 2 and 30.

By way of example, the suspension in step (i) may be a suspension comprising thin silver nanowires together with secondary silver nanoparticles distinct from said thin nanowires.

In general, the thin metal nanowires and the secondary metal nanoparticles are present in the suspension in step (i) of the process of the invention in a nanowires/secondary nanoparticles ratio by mass of between 70/30 and 99.5/0.5.

Preferably, the metal nano-objects are formed solely of said thin metal nanowires and said secondary metal nanoparticles, as described above. In other words, the suspension in step (i) of the process of the invention is formed from a mixture of thin metal nanowires and secondary metal nanoparticles, as described above, in an aqueous-alcoholic solvent medium.

According to a particular embodiment, the suspension in step (i) of the process of the invention is a suspension of silver nano-objects. In other words, the metal nano-objects of the suspension in step (i) comprise, or are formed of, a mixture of thin silver nanowires and secondary silver nanoparticles distinct from said thin nanowires.

Aqueous-Alcoholic Solvent Medium

The term “solvent medium” is intended to denote a single solvent or a mixture of at least two solvents.

The term “aqueous-alcoholic solvent medium” is intended to denote a medium comprising one or more solvents chosen from water and/or alcohols, in particular C₁ to C₁₀ alcohols. The water may be present at an amount of 0 to 100% by mass in the aqueous-alcoholic solvent medium.

Preferably, the aqueous-alcoholic solvent medium comprises, or is formed of, one or more solvents chosen from water and/or C₁ to C₁₀, in particular C₁ to C₆, alcohols, preferably monoalcohols, in particular chosen from methanol, ethanol and propanol, preferably methanol.

By way of example, the aqueous-alcoholic solvent medium in step (i) may be methanol.

The aqueous-alcoholic solvent medium has a viscosity at 25° C. of strictly less than 10 mPa·s. In particular, the aqueous-alcoholic solvent medium may have a viscosity at 25° C. of less than or equal to 5 mPa·s, preferably less than or equal to 3 mPa·s, more particularly less than or equal to 2 mPa·s and in particular ranging from 0.1 to 1 mPa·s.

The viscosity can be measured by any conventional method known to those skilled in the art, for example using a rotational viscometer, vibrating-body viscometer or a capillary tube viscometer.

According to a particular embodiment, the suspension of metal nano-objects comprising the thin metal nanowires in step (i) of the process of the invention has a concentration by mass of metallic material (constituting said metal nanowires and secondary nanoparticles) of between 0.01% and 5% by mass, in particular between 0.1% and 2.0% by mass.

In the case of the purification of silver nanowires, the concentration of silver in the suspension of metal nano-objects in step (i) may thus be between 0.01% and 5% by mass, in particular between 0.1% and 2.0% by mass.

In particular, the suspension of metal nano-objects comprising the thin metal nanowires in step (i) of the process of the invention may have a concentration by mass of metallic material constituting said metal nanowires, for example of silver in the case of silver nanowires, of between 0.1 and 10 g/L, in particular between 1 and 5 g/L.

This concentration can for example be measured by plasma torch spectrometry (ICP-MS or ICP-OES) or by atomic absorption spectrometry.

Of course, those skilled in the art are quite capable of adapting the concentration of metallic material in the starting suspension by addition, in a suitable amount, of one or more aqueous-alcoholic solvents, in particular as described above.

Preparation of the Suspension of Metal Nano-Objects of Step (i)

The suspension of metal nano-objects of step (i) of the process of the invention, as described above, may be obtained from the reaction mixture obtained on conclusion of a conventional synthesis of nanowires in solution, and more particularly after a first settling-out step as described in document EP 3 021 230.

Thus, according to a particular embodiment, the suspension of metal nano-objects in step (i) can more particularly obtained be via the steps consisting in:

(a) providing a mixture of metal nano-objects, including thin nanowires as described above and secondary nanoparticles, in particular as defined above, in the form of a dispersion in a solvent medium having a viscosity at 25° C. of greater than or equal to 10 mPa·s, in particular of between 10 and 50 mPa·s;

(b) leaving the dispersion of step (a) to settle out under conditions conducive to the formation of a supernatant phase comprising said small particles and of a precipitate comprising said metal nano-objects; and

(c) isolating the precipitate obtained on conclusion of the settling out (b) and dispersing it in an aqueous-alcoholic solvent medium having a viscosity of strictly less than 10 mPa·s, in particular as described above, to obtain said suspension of metal nano-objects.

Thus, according to a particular embodiment, the process for purifying metal nanowires according to the invention can be implemented to isolate thin metal nanowires from their synthesis reaction mixture, and can comprise the following steps:
providing a mixture of metal nano-objects as defined above, including thin metal nanowires and secondary nanoparticles, in the form of a dispersion in a solvent medium having a viscosity at 25° C. of greater than or equal to 10 mPa·s;
leaving the dispersion to settle out under conditions conducive to the formation of a supernatant phase comprising said small particles and of a precipitate comprising said metal nano-objects; and
isolating the precipitate obtained on conclusion of the settling out and dispersing it in an aqueous-alcoholic solvent medium having a viscosity at 25° C. of strictly less than 10 mPa·s, to obtain a suspension of metal nano-objects;
adding, to said suspension of metal nano-objects, nanoparticles of metal or metalloid oxide(s);
leaving the suspension of nano-objects supplemented with said nanoparticles of metal or metalloid oxide(s) to settle out under conditions conducive to the precipitation of said thin metal nanowires; and
recovering the settled material formed of said thin metal nanowires.

The starting mixture, comprising the metal nano-objects including thin metal nanowires as described above, together with undesirable small metal particles, in the form of a dispersion in a solvent medium, may be the reaction mixture obtained on conclusion of a conventional synthesis of nanowires in solution, if appropriate diluted with one or more solvents.

The protocols for synthesizing metal nanowires are well known to those skilled in the art. In general, they involve the reduction of metal salts, for example of silver nitrate for the synthesis of silver nanowires, by a polyol, typically ethylene glycol, in the presence of a nucleating agent (generally NaCl) and polyvinylpyrrolidone (PVP). PVP acts as a blocking agent, capable of controlling the growth rates of the various surfaces of silver nanocrystals. By way of example, it may be the reaction mixture obtained on conclusion of the synthesis described in the publication by Toybou et al., Environ. Sci.: Nano, 2019, 6, 684 [4].

According to a particular embodiment, the solvent medium for the dispersion of step (a) is formed of a single solvent. It may for example be formed of the reaction solvent which was employed for the synthesis of the metal nanowires, conventionally chosen from polyols having from 2 to 6 carbon atoms, typically ethylene glycol.

According to yet another variant embodiment, the solvent medium for the dispersion of step (a) may be formed of one or more solvents different from the reaction solvent used for the synthesis of the metal nanowires. The mixture in step (a) may for example be obtained from the synthesis reaction mixture, after separation of the reaction solvent and addition of one or more solvents of a different nature.

According to yet another variant embodiment, the solvent medium for the dispersion of step (a) may be formed of the reaction solvent, typically ethylene glycol, to which one or more solvents preferably chosen from monoalcohols, in particular C₁ to C₁₀, more particularly C₁ to C₆, monoalcohols, such as isopropanol, have been added.

In particular, the mixture in step (a) may be the reaction mixture, obtained directly on conclusion of the synthesis of the nanowires, to which an additional volume of solvent(s), in particular chosen from monoalcohols, for example isopropanol, has optionally been added for dilution purposes.

Preferably, the additional solvent(s), preferably the monoalcohol(s), for example isopropanol, is/are employed in the reaction mixture for synthesis of the nanowires (also called the “crude reaction mixture”), in a solvent(s):reaction mixture ratio by volume ranging from 1:10 to 10:1, preferably from 2:1 to 1:2 and more particularly of 1:1.

According to a particular embodiment, the solvent medium for the dispersion in step (a) comprises, in particular is formed of, one or more solvents chosen from polyols having from 2 to 6 carbon atoms, preferably diols having from 2 to 4 carbon atoms, in particular chosen from ethylene glycol and propylene glycol, optionally in a mixture with one or more monoalcohols, in particular C₁ to C₁₀ monoalcohols, preferably isopropanol.

Preferably, said polyol(s), preferably ethylene glycol, and said monoalcohol(s), in particular isopropanol, are present in a polyol(s)/monoalcohol(s) ratio by volume ranging from 1:10 to 10:1, preferably from 2:1 to 1:2 and more particularly of 1:1.

According to a particular embodiment, the mixture of step (a) has a concentration of metallic material constituting said metal nanowires of between 0.1 and 10 g/L, in particular between 1 and 4 g/L.

In the case of silver nanowires, the concentration of silver in the mixture of step (a) may thus be between 0.1 and 10 g/L, in particular between 1 and 4 g/L.

This concentration can for example be measured by plasma torch spectrometry (ICP-MS or ICP-OES) or by atomic absorption spectrometry.

Of course, those skilled in the art are quite capable of adapting the concentration of metallic material in the starting mixture by addition, in a suitable amount, of one or more solvents, in particular of one or more monoalcohols as described above, for example of isopropanol.

As indicated above, the mixture of step (a) is then left to settle out. This first settling out makes it possible to separate a portion of the undesirable small particles as described above from the metal nano-objects (thin nanowires and secondary nanoparticles) present in the mixture.

More precisely, this first settling out results in a supernatant comprising a portion of the small particles dispersed in the solvent medium, while the precipitate (also called “sediment” or “settled material”), resulting from the settling out, comprises the metal nano-objects including the thin nanowires of interest.

It is up to those skilled in the art to adjust the operating conditions of the settling out, in particular in terms of duration, in order to obtain the desired separation, in particular with regard to the nature of the solvent medium of the initial mixture.

The settling out may be carried out at ambient temperature.

In general, the settling out in step (b) may be carried out for a duration ranging from 2 hours to 18 hours, preferably from 4 hours to 12 hours, in particular for around 10 hours. Of course, the duration of this first settling out may be reduced, but to the detriment of the quality of the separation. It is understood that an excessively short settling-out duration may result in a loss of a significant amount of nanowires which would not be settled out. The precipitate, obtained on conclusion of this first settling-out step, comprising the majority of the thin metal nanowires initially present in the mixture (a), is then isolated and then dispersed in an aqueous-alcoholic solvent medium as described above.

The settled product may for example be recovered by removing the supernatant phase by means of a suction system, for example a pipette.

The removed supernatant phase can be treated separately for recovering the starting materials, in particular recycling of the metallic material, such as silver.

Settling Out Assisted by Nanoparticles of Metal or Metalloid Oxide(s)

Nanoparticles of Metal or Metalloid Oxide(s)

As indicated above, in a step (ii) of the process of the invention, the suspension of metal nano-objects including the thin nanowires of interest, for example obtained as described above, is supplemented with nanoparticles of metal or metalloid oxide(s).

These nanoparticles of metal or metalloid oxide(s) may advantageously be spherical in shape. The term “spherical” particle is intended to denote particles having the shape or substantially the shape of a sphere.

The nanoparticles of metal or metalloid oxide(s) employed according to the invention have an average diameter of less than or equal to 50% of the average diameter of the thin metal nanowires, in particular less than or equal to 20% of the average diameter of the thin metal nanowires, preferably less than or equal to 10% of the average diameter of the thin metal nanowires.

In particular, they may have an average diameter of less than or equal to 25 nm, preferably less than or equal to 15 nm and in particular between 5 and 12 nm.

The nanoparticles of metal or metalloid oxide(s) may have a specific surface area, measured according to the BET method, of between 80 and 500 m²/g, in particular of between 100 and 250 m²/g.

The nanoparticles are composed of a material chosen from metal oxides, metalloid oxides, and mixtures thereof, in particular from alumina (Al₂O₃), silica (SiO₂), and iron, manganese, titanium and zinc oxides.

According to a particular embodiment, the nanoparticles of metal or metalloid oxide(s) employed according to the invention are silica nanoparticles.

The nanoparticles of metal or metalloid oxide(s) may be added to the suspension of metal nano-objects in the form of a suspension of said nanoparticles in an aqueous-alcoholic solvent medium, as defined above.

For example, they may be employed in the form of a suspension of nanoparticles of metal or metalloid oxide(s) in one or more solvents chosen from water and C₁ to C₁₀ monoalcohols, for example methanol.

The suspension of nanoparticles of metal or metalloid oxide(s) may be commercially available or else be prepared by dilution, for example in one or more monoalcohols, from a commercially available suspension.

As examples, mention may be made of the suspensions of silica nanoparticles sold under the Ludox® references by Sigma-Aldrich.

Preferably, the nanoparticles of metal or metalloid oxide(s) are introduced into the suspension of metal nano-objects comprising said thin nanowires of interest in a thin metal nanowires/nanoparticles of metal or metalloid oxide(s) ratio by mass of between 1:1 and 1.100.

In particular, the thin metal nanowires/nanoparticles of metal or metalloid oxide(s) ratio by mass can be between 1:2 and 1:20 and more particularly from 1:8 to 1:12, in particular be around 1:10.

The suspension of metal nano-objects supplemented with said nanoparticles of metal or metalloid oxide(s) advantageously has a concentration by mass of metallic material constituting said metal nanowires, for example of silver in the case of the purification of silver nanowires, of between 0.1 and 10 g/L, in particular between 1 and 5 g/L.

Settling Out

In a step (iii) of the process of the invention, the suspension of metal nano-objects, supplemented with said nanoparticles of metal or metalloid oxide(s), is left to settle out.

This second settling out results in a precipitate (settled material) comprising the thin metal nanowires, while the secondary nanoparticles distinct from said nanowires remain in the supernatant.

It is up to those skilled in the art to adjust the operating conditions of the settling out, in particular in terms of duration, in order to obtain the desired separation.

The settling out may be carried out at ambient temperature.

Advantageously, a good separation of the thin metal nanowires and of the secondary nanoparticles can be obtained for a short settling-out duration, in particular for a duration of less than or equal to 6 hours, more particularly between 2 and 4 hours.

Advantageously, on conclusion of the settling out, the settled material comprises more than 80% of the thin metal nanowires present in the starting suspension of nano-objects, in particular more than 90% of the thin metal nanowires.

Advantageously, the settled material comprises less than 10% by mass, in particular less than 5% by mass and advantageously less than 2% by mass of metal nano-objects other than the desired thin nanowires.

Of course, the duration of the settling out may be reduced to the detriment of the quality of the separation, depending on the amount of byproducts admissible with the thin metal nanowires.

On conclusion of this settling-out step, the settled material, formed essentially of thin metal nanowires having on their surface said nanoparticles of metal or metalloid oxide(s), is isolated from the supernatant phase.

As for the supernatant phase comprising the secondary metal nanoparticles, for example the silver nanoparticles, distinct from said thin nanowires, this may be treated separately for recovery of the starting materials, in particular recycling of the metallic material, for example silver.

With a view to the use thereof for the formation of percolating networks, the settled material obtained on conclusion of step (iv), consisting essentially of the thin metal nanowires, for example the thin silver nanowires, on the surface of which nanoparticles of metal or metalloid oxide(s) are present, can be redispersed in an aqueous-alcoholic solvent medium, for example in water or methanol, said dispersion being able to be used to form a percolating network of metal nanowires.

It is up to those skilled in the art to adjust the content of aqueous-alcoholic solvent medium in order to obtain the desired concentration of metal nanowires, typically a concentration of metallic material of between 50 and 1000 mg/L.

The metal nanowires purified on conclusion of the process of the invention, dispersed in an aqueous-alcoholic solvent medium, may be used to manufacture transparent electrically conductive materials, for example a transparent electrode.

The methods for manufacturing such transparent electrically conductive materials are known to those skilled in the art.

For example, a percolating network of nanowires can be deposited at the surface of a substrate, for example a glass substrate, from the suspension of nanowires, for example by nebulization, vaporization, spin coating, coating, screen printing, etc., preferably by spray coating.

Advantageously, the presence of nanoparticles of metal or metalloid oxide(s) in the dispersion of thin metal nanowires does not adversely affect the performance of the percolating network based on said metal nanowires. The presence of such nanoparticles of metal or metalloid oxide(s), such as silica nanoparticles, can improve the dispersion of the metal nanowires, such as silver nanowires, in the polymer matrices, such as epoxy matrices, for the formation of nanocomposites.

### EXAMPLE

### Example 1 (Counterexample)

Conventional Purification of Nanowires

The silver nanowires are synthesized according to the synthesis in polyol medium described in the publication Environ. Sci.: Nano, 2019, 6, 684 [4], to obtain nanowires with an average length of 10 μm and an average diameter of 30 nm.

The reaction mixture is cooled after synthesis of the nanowires.

The mixture, with a concentration by mass of silver of 4 g/kg, is then dispensed into crystallizers of 10 cm diameter. The suspension is present to a height of 6 cm.

The mixture is left to settle out for 72 hours.

On conclusion of the 72 hours of settling out, the separation between the nanoparticles and the nanowires of interest is insufficient and few of the nano-objects can be recovered.

The nanowires present in the isolated settled material are usable for the manufacture of electrodes, but still contain a non-negligible amount of secondary nanoparticles.

It takes about three weeks, in several settling-out steps, to obtain a satisfactory separation (less than 5% by mass of silver nanoparticles relative to the nanowires of interest).

### Example 2 (Counterexample)

Purification by settling out without the assistance of nanoparticles of metal or metalloid oxide(s)

The silver nanowires are synthesized as described in example 1.

The reaction mixture is cooled after synthesis of the nanowires. Isopropanol is added to this mixture of 4 g/kg of silver (1:1 by volume). The settled material obtained after 12 hours is isolated and redispersed in methanol.

This suspension, containing most of the silver nano-objects (nanowires and undesirable silver nanoparticles) is left to settle out for 4 hours in crystallizers with a liquid height of 6 cm.

No notable separation is observed between the thin nanowires and the secondary nanoparticles.

### Example 3

Purification by Settling Out Assisted with Nanoparticles of Metal or Metalloid Oxide(s)

The silver nanowires are synthesized as described in example 1.

The reaction mixture is cooled after synthesis of the nanowires. Isopropanol is added to this mixture of 4 g/kg of silver (1:1 by volume). The settled material obtained after 12 hours is isolated and redispersed in methanol.

To this suspension, containing most of the silver nano-objects (nanowires and undesirable silver nanoparticles) with a concentration of silver of 0.35% by mass, is added an aqueous-alcoholic solution prepared from several types of silica nanoparticle solutions sold under the Ludox® reference.

The properties of the silica nanoparticle solutions employed are summarized in the following table:

TABLE 1

| | | Specific | | | |
|---|---|---|---|---|---|
| Type of | Concentration | surface | | | |
| Ludox ® | by mass | area | | Density | Stabilized |
| solution | (in water) | (m²/g) | pH: | (g/mL) | by |
| AM-30 | 30% | 198-250 | 8.6-9.3 | 1.21 | sodium |
| AS-30 | 30% | 230 | 9.1 | 1.2 | ammonium |
| TMA | 34% | 140 | 4-7 | 1.23 | deionized |

Each of the Ludox Solutions® is diluted in methanol in order to obtain a concentration by mass close to that of the solution of silver nanowires (approximately 4 g per kg of solution).

A volume of solution of silver nanowires is mixed with a volume of aqueous-alcoholic Ludox® solution. These mixtures are created for different nanowires/silica nanoparticles ratios by mass: 1/1; 1/10 and 1/100.

The solutions are observed under a scanning electron microscope (SEM).

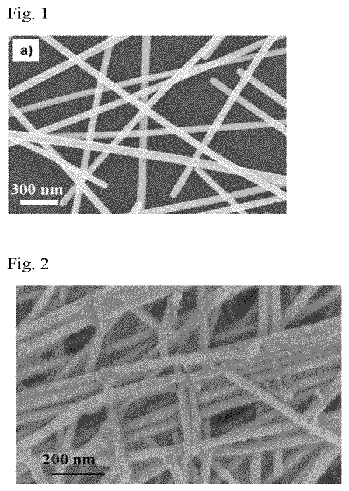

FIGS. 1 and 2 represent the SEM images obtained respectively for silver nanowires, and for the mixture of silver nanowires with silica nanoparticles from the Ludox® AM-30 solution, with a nanowires/nanoparticles ratio by mass of 1/10. It can be observed that the nanowires are well covered by the silica nanoparticles.

The solutions are left to settle out for four hours in crystallizers (with a liquid height of 6 cm).

The settling out is rapid. In this way, settling out for four hours results in a separation in quantity and of quality (less than 5% by mass of silver nanoparticles with a nonconforming aspect ratio, the ratio being estimated by scanning electron microscopy).

The nanowires thus purified make it possible to achieve the same electro-optical performance for two-dimensional percolating networks as the nanowires obtained after settling out for three weeks without addition of metal oxide nanoparticles.

### LIST OF CITED DOCUMENTS

[1] Langley et al., Nanotechnology 24 (2013] 452001 (20 pp);
[2] Nam et al., ACS Nano 7, 851-856 (2013);
[3] Cho et al., J. Appl. Phys. 115, 154307 (2014);
[4] Toybou et al., Environ. Sci.: Nano, 2019, 6, 684.

1. A process for purifying metal nanowires comprising:
(i) providing a suspension of metal nano-objects in an aqueous-alcoholic solvent medium having a viscosity at 25° C. of strictly less than 10 mPa·s, the metal nano-objects including:
thin nanowires having an aspect ratio of greater than or equal to 50 and an average diameter of less than or equal to 60 nm; and
secondary nanoparticles, distinct from the thin nanowires, having an aspect ratio of less than or equal to 30 and a volume-average equivalent diameter of less than or equal to 200 nm;
(ii) adding, to the suspension of metal nano-objects, nanoparticles of metal or metalloid oxide(s) having a diameter of less than or equal to 50% of the average diameter of the thin nanowires;
(iii) leaving the suspension of metal nano-objects supplemented with the nanoparticles of metal or metalloid oxide(s) to settle out under conditions conducive to precipitation of the thin nanowires; and
(iv) recovering settled material formed from the thin nanowires.

2. The process as claimed in claim 1, wherein the metal nano-objects of said suspension in step (i) comprise, or are formed of, thin silver nanowires and secondary silver nanoparticles distinct from the thin nanowires.

3. The process as claimed in claim 1, wherein said thin nanowires have at least one of an average diameter ranging from 10 to 60 nm and an aspect ratio of strictly greater than 50.

4. The process as claimed in claim 1, wherein the secondary metal nanoparticles, distinct from the thin nanowires, have at least one of an aspect ratio of less than or equal to 10 and a volume-average equivalent diameter of less than or equal to 100 nm.

5. The process as claimed in claim 1, wherein the aqueous-alcoholic solvent medium is formed of one or more solvents chosen from at least one of water and alcohols.

6. The process as claimed in claim 1, wherein the aqueous-alcoholic solvent medium has a viscosity at 25° C. of less than or equal to 5 mPa·s.

7. The process as claimed in claim 1, wherein said suspension of metal nano-objects in step (i) is obtained beforehand via the following steps:
(a) providing a mixture of metal nano-objects, including the thin nanowires and the secondary nanoparticles, in a form of a dispersion in a solvent medium having a viscosity at 25° C. of greater than or equal to 10 mPa·s;
(b) leaving the dispersion of step (a) to settle out under conditions conducive to formation of a supernatant phase comprising the small particles and of a precipitate comprising said metal nano-objects; and
(c) isolating the precipitate obtained on conclusion of the settling out in (b) and dispersing the precipitate in an aqueous-alcoholic solvent medium having a viscosity at 25° C. of strictly less than 10 mPa·s, to obtain the suspension of metal nano-objects.

8. The process as claimed in claim 7, wherein the mixture in step (a) is a reaction mixture obtained on conclusion of synthesis of the thin nanowires in solution.

9. The process as claimed in claim 1, wherein the nanoparticles of metal or metalloid oxide(s) employed in step (ii) have an average diameter of less than or equal to 20% of the average diameter of the thin nanowires.

10. The process as claimed in claim 1, wherein the nanoparticles of metal or metalloid oxide(s) employed in step (ii) are composed of a material chosen from metal oxides, metalloid oxides, and mixtures thereof.

11. The process as claimed in claim 1, wherein the nanoparticles of metal or metalloid oxide(s) are employed in step (ii) in a thin nanowires/nanoparticles of metal or metalloid oxide(s) ratio by mass of between 1:1 and 1:100.

12. The process as claimed in claim 1, wherein the suspension of metal nano-objects supplemented with the nanoparticles of metal or metalloid oxide(s), obtained on conclusion of step (ii), has a concentration by mass of metallic material constituting the metal nanowires, of between 0.1 and 10 g/L.

13. The process as claimed in claim 1, wherein the settling out in step (iii) is carried out for a duration of less than or equal to 6 hours.

14. The process as claimed in claim 1, wherein the settled material obtained on conclusion of step (iv) is redispersed in an aqueous-alcoholic solvent medium, the dispersion then being able to be used to form a percolating network of metal nanowires.

15. The process as claimed in claim 1, wherein said thin nanowires have at least one of an average diameter ranging from 20 to 50 nm and an aspect ratio between 200 and 1000.

16. The process as claimed in claim 1, wherein the secondary metal nanoparticles, distinct from the thin nanowires, have at least one of an aspect ratio between 1 and 8 and a volume-average equivalent diameter between 1 and 50 nm.

17. The process as claimed in claim 1, wherein the nanoparticles of metal or metalloid oxide(s) employed in step (ii) are composed of a material chosen from alumina (Al₂O₃), silica (SiO₂), and iron, manganese, titanium and zinc oxides.

18. The process as claimed in claim 1, wherein the nanoparticles of metal or metalloid oxide(s) employed in step (ii) are silica nanoparticles.

19. The process as claimed in claim 1, wherein the nanoparticles of metal or metalloid oxide(s) are employed in step (ii) in a thin nanowires/nanoparticles of metal or metalloid oxide(s) ratio by mass of between 1:2 and 1:20.

20. The process as claimed in claim 8, comprising adding an additional volume of solvent(s) to the solution for dilution purposes.
